(19) United States
(12) Patent Application Publication
(10) Pub. No.: US 2010/0145245 A1
(43) Pub. Date: Jun. 10, 2010

(54) Massage chair for massaging the thighs and the lumbar part

(76) Inventor: Ko-Po Chen, Ta-Li City (TW)

Correspondence Address: PRO-TECHTOR INTERNATIONAL SERVICES, 20775 NORADA CT., SARATOGA, CA, 95070, US

(21) Appl. No.: 12/315,802

(22) Filed: Dec. 4, 2008

(51) Int. Cl. A61H 23/04

(52) U.S. Cl. 601/149

(57) ABSTRACT

A massage chair includes a seat board comprising two side air cushions for thighs massage each having folded first air bladders adapted to communicate air with an air pump under the seat board; a padded chair seat comprising two pivotal thighs zones on the air cushions for thighs massage respectively; a back comprising two side air cushions for lumbar massage each having folded second air bladders adapted to communicate air with the air pump; and a padded backrest comprising two pivotal lumbar zones on the air cushions for lumbar massage respectively. The seat board and the chair seat are releasably secured together. Also, the back and the backrest are releasably secured together. The massage chair can exert a sufficient force to a seated person for massage.

### BACKGROUND OF THE INVENTION

1. Field of Invention

The invention relates to massage chairs and more particularly to ah -electric massage chair for massaging both the thighs and the lumbar part with improved characteristics.

2. Description of Related Art

A conventional electric massage chair is shown in FIGS. 1 to 4. The massage chair comprises a back frame 11 with a padded backrest 13 mounted thereon a seat frame 12 with a padded chair seat 14 mounted thereon, an air cushion for lumbar massage 15 having an outer air bladder 152 and a plurality of folded inner air bladders 151, an air pump 16 being adapted to communicate air with the inner air bladders 151, and an air cushion for thighs massage 17 having an outer air bladder 172 and a plurality of folded inner air bladders 171 being adapted to communicate air with the air pump 16.

A user seated on the massage chair may turn on the power to massage, for example, the thighs 18 as shown in FIGS. 3 and 4. In response in a first cycle, the air pump 16 activates to inflate the inner air bladders 171. And in turn, the outer air bladder 172 pivotably bulges to press the thighs 18. In a second cycle, the air pump 16 deactivates to deflate the inner air bladders 171. And in turn, the outer air bladder 172 pivotably contract to be substantially flat to stop the pressing. The first and second cycles may repeat until the user is satisfied by turning off the power.

However, the well known massage chair suffered from several disadvantages. For example, the air cushion for lumbar massage 15 and the air cushion for thighs massage 17 are directly provided on the backrest 13 and the chair seat 14 respectively. This is not aesthetic. Further, only small areas of the thighs 18 are pressed by the bulged outer air bladder 172 (see FIG. 3). Hence, the massage effect is poor. Furthermore, the user may feel a degree of discomfort on the thighs 18 because the bulged air cushion for thighs massage 17 pressing the thighs 18 is somewhat hard. In addition, as regard to the air cushion for thighs massage 17, a great portion of its bulging force is absorbed by the padded chair seat 14. Hence, the pressing force exerted upon the thighs 18 by the air cushion for thighs massage 17 is greatly reduced. That is, the massage force is not sufficient.

There have been numerous suggestions in prior patents for massage chair. For example, U.S. Pat. No. 7,285,102 discloses a dual use massage chair. Thus, continuing improvements in the exploitation of massage chair are constantly being sought.

### SUMMARY OF THE INVENTION

It is therefore one object of the invention to provide a massage chair for massaging both the thighs and the lumbar part.

The above and other objects, features and advantages of the invention will become apparent from the following detailed description taken with the accompanying drawings.

### BRIEF DESCRIPTION OF THE DRAWINGS

FIG. 1 is a perspective view of a conventional electric massage chair;

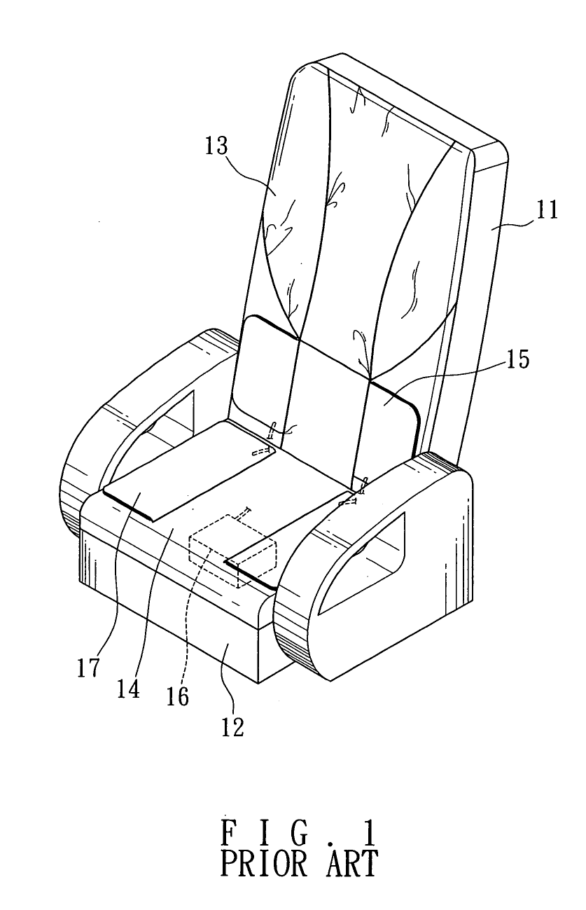

FIG. 2 is a sectional view of the backrest or the chair seat of FIG. 1 with details of the air cushion for lumbar massage or the air cushion for thighs massage being shown in an oval;

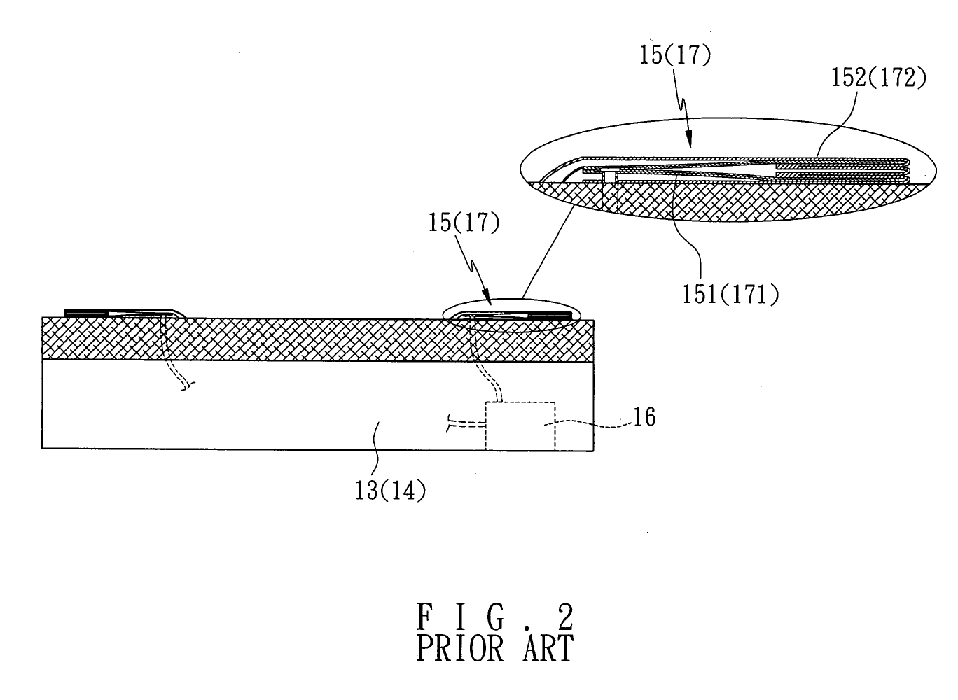

FIG. 3 is an enlarged view of FIG. 2 for illustrating the massage operation of the air cushion for thighs massage in which the air cushion for thighs massage is bulged to press the thighs;

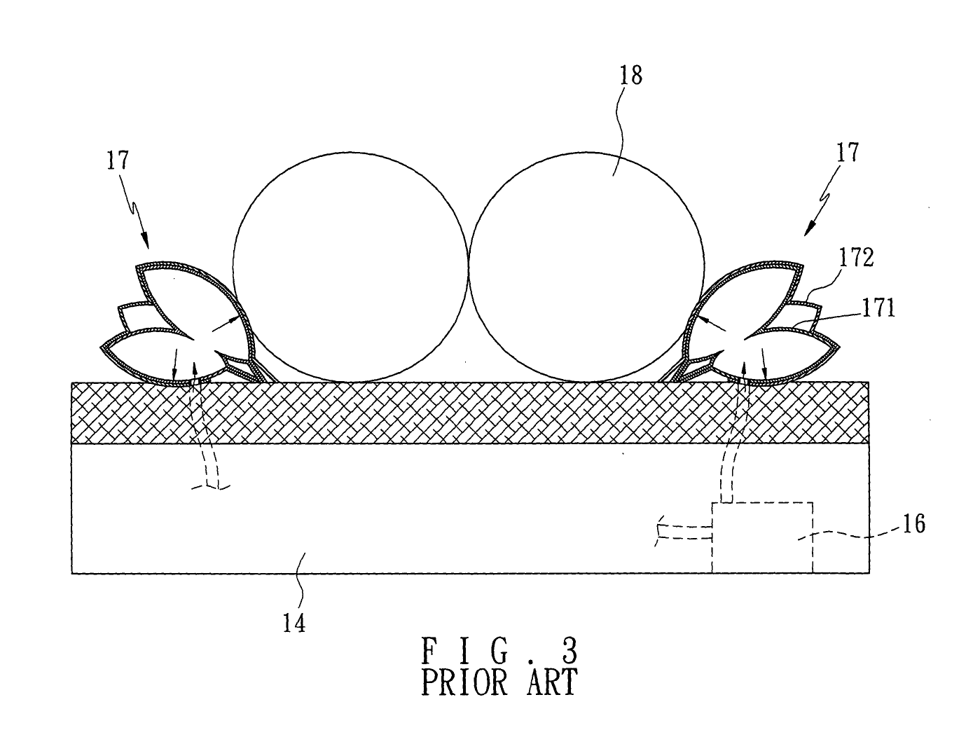

FIG. 4 is a view similar to FIG. 3 where the air cushion for thighs massage is contracted to stop the pressing with details of the air cushion for thighs massage being shown in an oval;

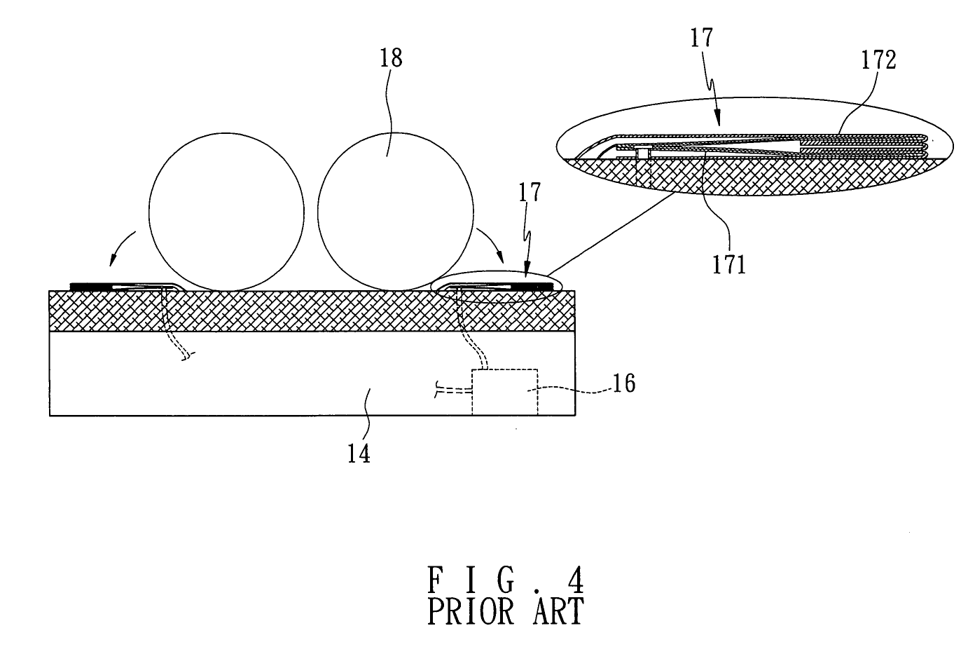

FIG. 5 is an exploded view of a preferred embodiment of massage chair according to the invention;

FIG. 6 is a perspective view of the assembled massage chair of FIG. 5;

FIG. 7 is a sectional view of the backrest of FIG. 6 with details of the air cushion for lumbar massage being shown in an oval;

FIG. 8 is a sectional view of the chair seat of FIG. 6 with details of the air cushion for thighs massage being shown in an oval;

FIG. 9 is an enlarged view of FIG. 7 for illustrating the massage operation of the air cushion for lumbar massage in which the air cushion for lumbar massage is bulged to press the lumbar part;

FIG. 10 is a view similar to FIG. 9 where the air cushion for lumbar massage is contracted to stop the pressing with details of the air cushion for lumbar massage being shown in an oval;

FIG. 11 is an enlarged view of FIG. 8 for illustrating the massage operation of the air cushion for thighs massage in which the air cushion for thighs massage is bulged to press the thighs; and

FIG. 12 is a view similar to FIG. 11 where the air cushion for thighs massage is contracted to stop the pressing with details of the air cushion for thighs massage being shown in an oval.

### DETAILED DESCRIPTION OF THE INVENTION

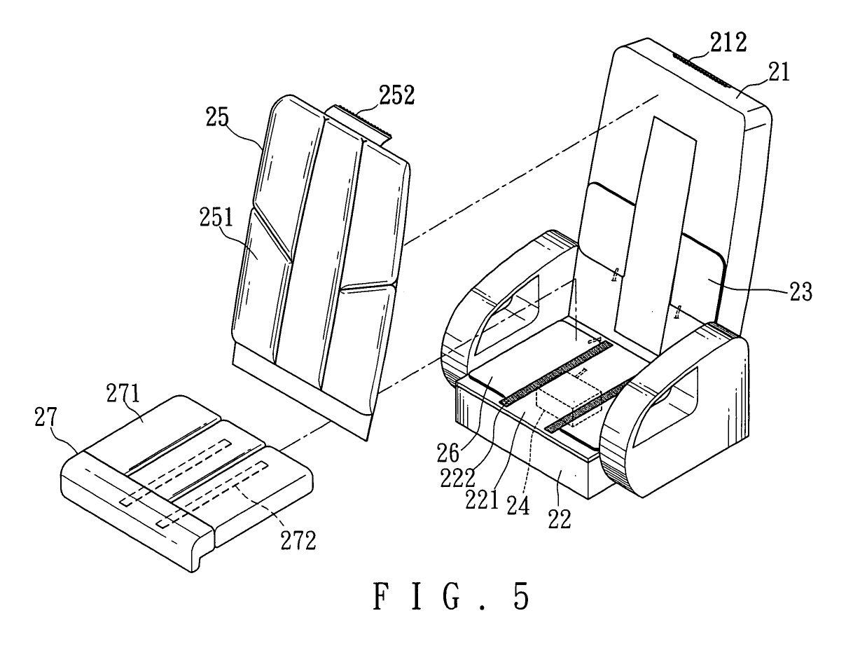

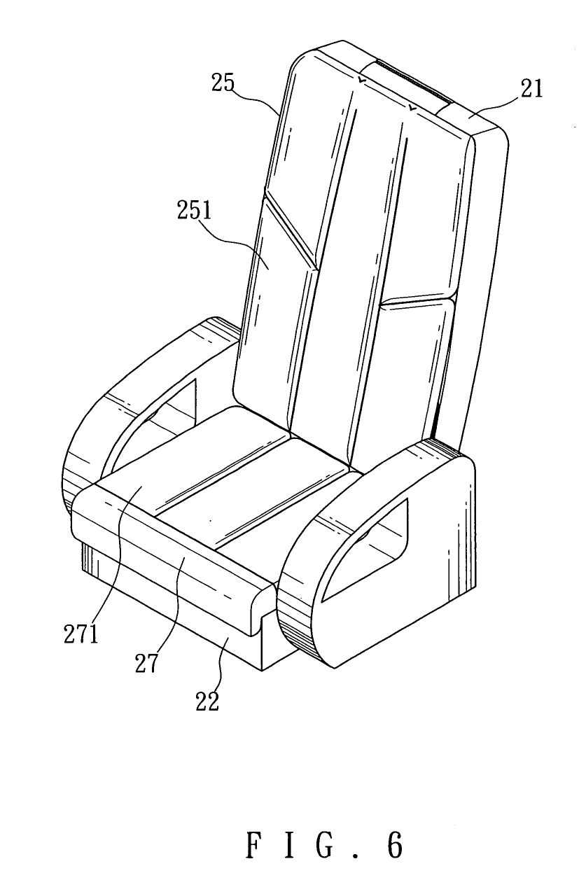

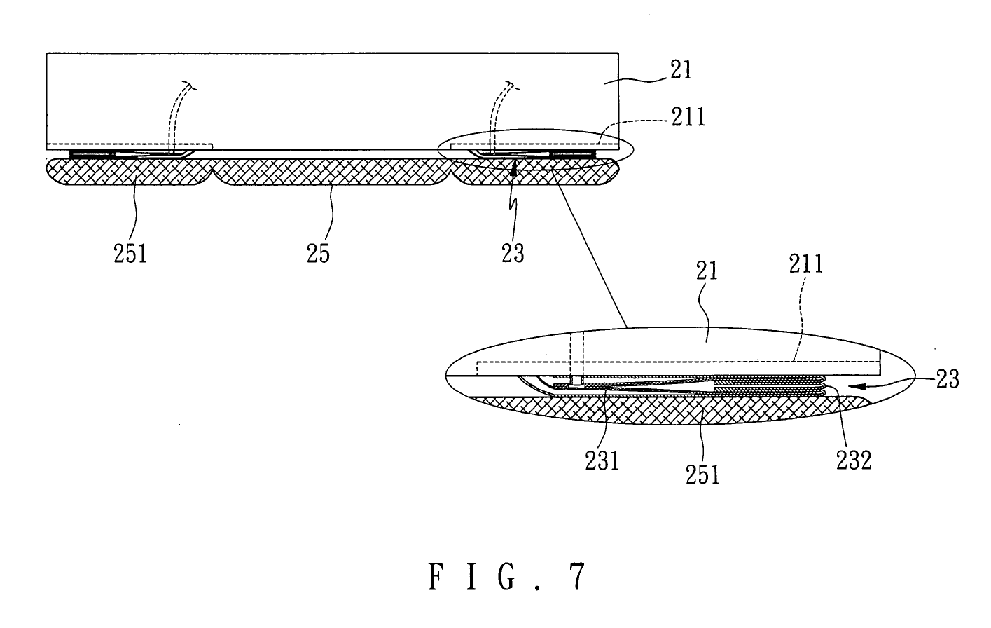

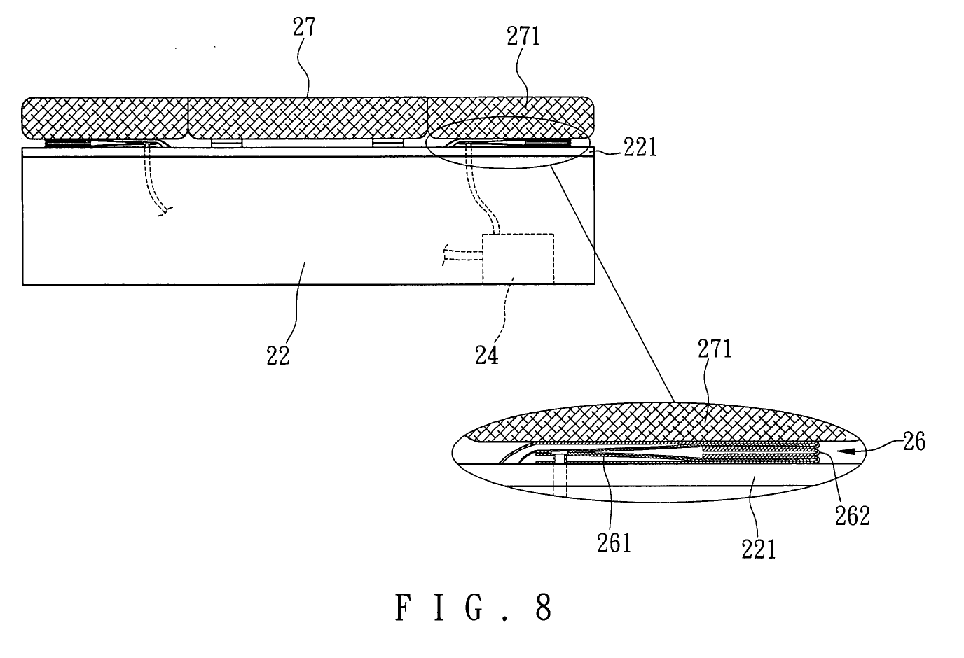

Referring to FIGS. 5 to 8, a massage chair in accordance with a preferred embodiment of the invention comprises the following components as discussed in detail below.

A rectangular back frame 21 has two hard boards 211 mounted thereon proximate both sides, and two inflatable air cushions for lumbar massage 23 mounted on the boards 211 being substantially flush with the lumbar part of a seated person. A padded backrest 25 of substantially rectangular has two opposite pivotal lumbar zones 251. The lumbar zones 251 are substantially aligned with the air cushions for lumbar massage 23. Each of the air cushion for lumbar massage 23 has an outer air bladder 232 and a plurality of folded inner air bladders 231 being adapted to communicate air with an air pump 24 disposed below a seat frame 22. The backrest 25 has a zipper section 252 on the top edge. The zipper section 252 is adapted to matingly engage with a corresponding zipper section 212 on the top edge of the back frame 21 so as to secure the backrest 25 onto the back frame 21 between two arm pads (not numbered).

The rectangular seat frame 22 has a hard board 221 mounted thereon. Two opposite, inflatable air cushions for thighs massage 26 adjacent the arm pads are provided on the board 221. Each air cushion for thighs massage 26 has an outer air bladder 262 and a plurality of folded inner air bladders 261 being adapted to communicate air with the air pump 24.

A rectangular padded chair seat 27 has two pivotal thighs zones 271 on both sides respectively. Two elongated parallel hook and loop fabric fasteners 272 are provided on the bottom of the chair seat 27. Also, two elongated parallel corresponding hook and loop fabric fasteners 222 are provided on the top of the board 221. The chair seat 27 is adapted to secure onto the hard board 221 by attaching the hook and loop fabric fasteners 272 onto the corresponding hook and loop fabric fasteners 222.

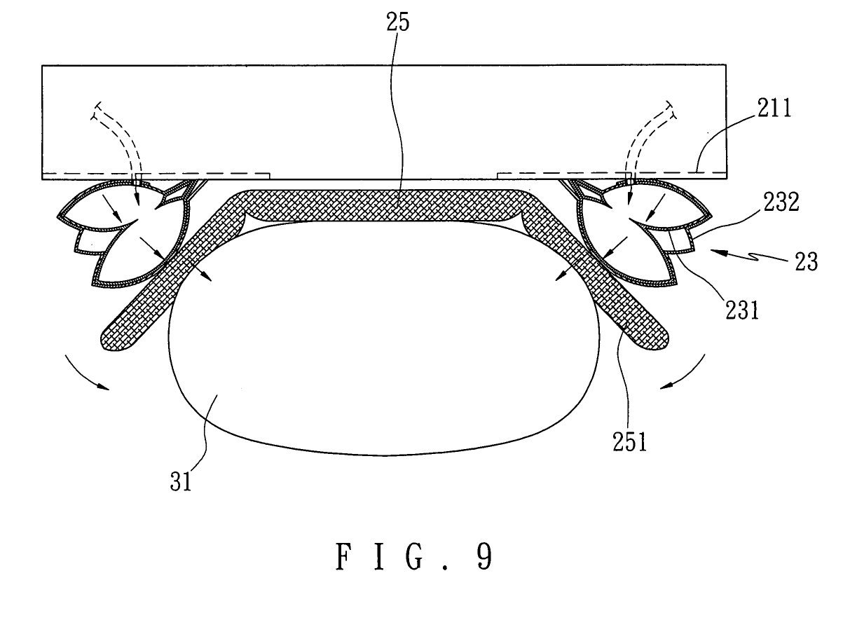

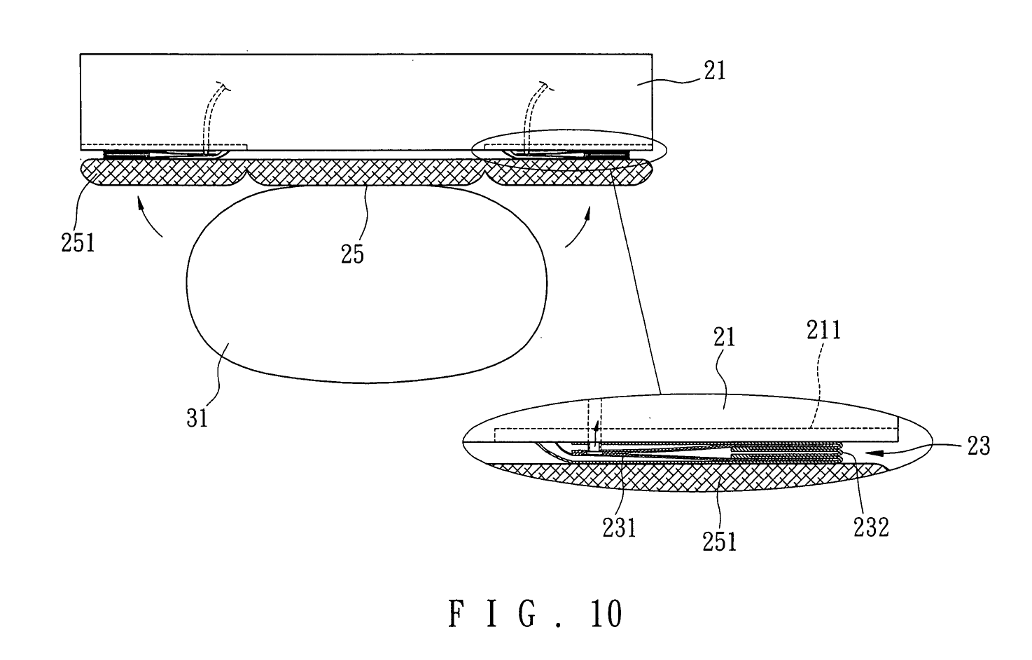

Referring to FIGS. 9 and 10, a lumbar massage is discussed below.

A user seated on the massage chair may turn on the power. In response in a first cycle (see FIG. 9), the air pump 24 activates to inflate the inner air bladders 231 by pumping air thereinto as indicated by arrows. And in turn, the outer air bladder 232 pivotably bulges to pivot the lumbar zones 251 as indicated by arrows. And in turn, a lumbar part 31 of the user is pressed by the pivoting, resiliently compressed lumbar zones 251 as indicated by arrows.

In a second cycle (see FIG. 10), the air pump 24 deactivates to deflate the inner air bladders 231. And in turn, the outer air bladder 232 pivotably contracts to be substantially flat to stop the pressing. At the same time, the lumbar zones 251 pivot to its inoperative position as indicated by arrows, i.e., the backrest 25 returning to a flat one. The first and second cycles may repeat until the user is satisfied by turning off the power.

It is appreciated that the expansion force of the air cushions for lumbar massage 23 is substantially completely exerted upon the lumbar zones 251 due to the provision of the boards 211. And in turn, the force is exerted upon the lumbar part 31 by the lumbar zones 251. Moreover, the contact area of the lumbar part 31 and the lumbar zones 251 is increased significantly. As a result, not only the pressing force exerted upon the lumbar part 31 is increased greatly but also the user may feel a degree of comfort while massaging.

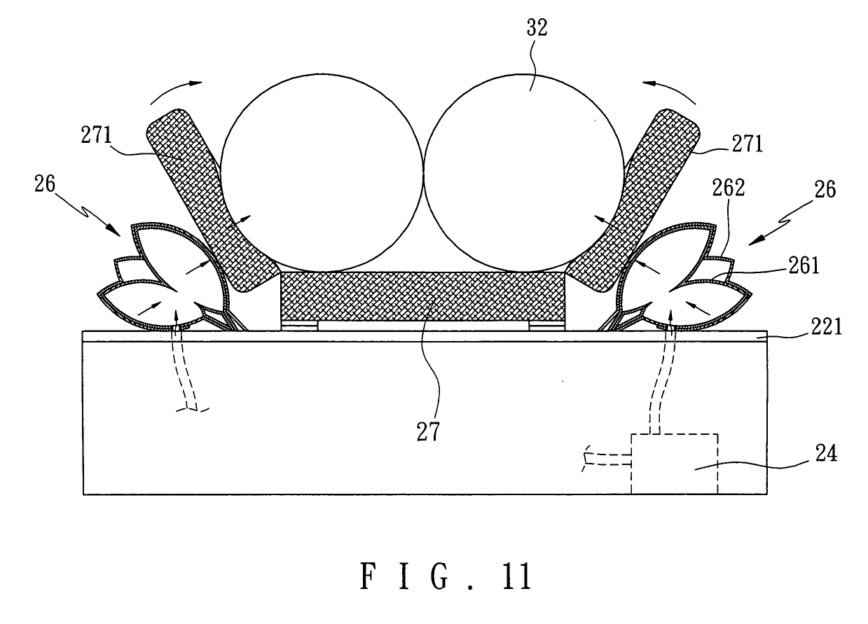

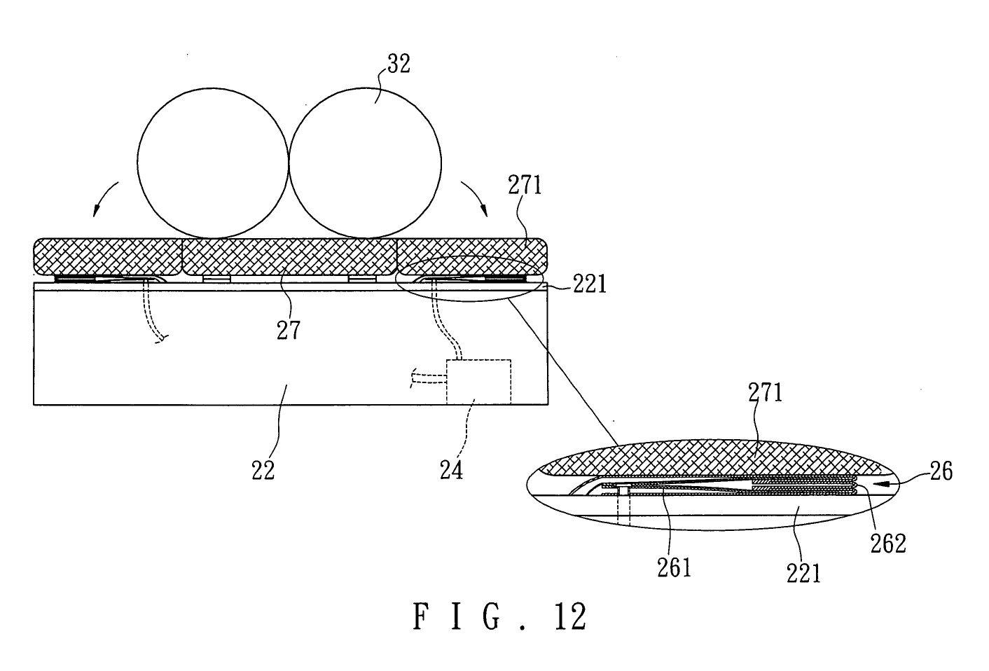

Referring to FIGS. 11 and 12, thighs massage is discussed below.

A user seated on the massage chair may turn on the power. In response in a first cycle (see FIG. 11), the air pump 24 activates to inflate the inner air bladders 261 by pumping air thereinto as indicated by arrows. And in turn, the outer air bladder 262 pivotably bulges to pivot the thighs zones 271 as indicated by arrows. And in turn, thighs 32 of the user are pressed by the pivoting, resiliently compressed thighs zones 271 as indicated by arrows.

In a second cycle (see FIG. 12), the air pump 24 deactivates to deflate the inner air bladders 261. And in turn, the outer air bladder 262 pivotably contracts to be substantially flat to stop the pressing. At the same time, the thighs zones 271 pivot to its inoperative position as indicated by arrows, i.e., the chair seat 27 returning to a flat one. The first and second cycles may repeat until the user is satisfied by turning off the power.

It is appreciated that the lumbar and thighs massage operations can be performed individually or at the same time. Further, the expansion force of the air cushions for thighs massage 26 is substantially completely exerted upon the lumbar zones 251 due to the provision of the boards 221. And in turn, the force is exerted upon the thighs 32 by the thighs zones 271. Moreover, the contact area of the thighs 32 and the thighs zones 271 is increased significantly. As a result, not only the pressing force exerted upon the thighs 32 is increased greatly but also the user may feel a degree of comfort while massaging.

While the invention herein disclosed has been described by means of specific embodiments, numerous modifications and variations could be made thereto by those skilled in the art without departing from the scope and spirit of the invention set forth in the claims.

What is claimed is:

1. A massage chair comprising:
a seat board comprising two inflatable air cushions for thighs massage proximate both sides of a top surface respectively, each of the air cushions for thighs massage having a plurality of first air bladders which are folded in an inoperative state, and first fastening means between the air cushions for thighs massage;
an air pump mounted below the seat board and adapted to communicate air with first air bladders;
a padded chair seat comprising two pivotal thighs zones on the air cushions for thighs massage respectively, and second fastening means between the thighs zones, the second fastening means being attached to the first fastening means to secure the chair seat to the seat board;
a back comprising two inflatable air cushions for lumbar massage proximate both sides of a front surface respectively, each of the air cushions for lumbar massage having a plurality of second air bladders which are folded in an inoperative state and adapted to communicate air with the air pump, and third fastening means; and
a padded backrest comprising two pivotal lumbar zones on the air cushions for lumbar massage respectively, and fourth fastening means attached to the third fastening means to secure the backrest to the back,
whereby activating the air pump in a first mode in a first cycle, the first air bladders are inflated to pivotably bulge the air cushions for thighs massage which in turn pivot and resiliently compress the thighs zones to press thighs of a seated person; and deactivating the air pump in a second cycle, the first air bladders are deflated to pivotably contract the air cushions for thighs massage to stop compressing the thighs zones and pivotably return the thighs zones to its inoperative state; and
whereby activating the air pump in a second mode in a first cycle, the second air bladders are inflated to pivotably bulge the air cushions for lumbar massage which in turn pivot and resiliently compress the lumbar zones to press lumbar part of the seated person; and deactivating the air pump in a second cycle, the second air bladders are deflated to pivotably contract the air cushions for lumbar massage to stop compressing the lumbar zones and pivotably return the lumbar zones to its inoperative state.

2. The massage chair of claim 1, wherein the first fastening means is one or more hook and loop fabric fasteners, and the second fastening means is one or more corresponding hook and loop fabric fasteners.

3. The massage chair of claim 1, wherein the third fastening means is one or more hook and loop fabric fasteners, and the fourth fastening means is one or more corresponding hook and loop fabric fasteners.

4. The massage chair of claim 1, wherein the third and fourth fastening means are implemented as a zipper.
